(19) United States
(12) Patent Application Publication
(10) Pub. No.: US 2007/0267837 A1
(43) Pub. Date: Nov. 22, 2007

(54) ADJUSTABLE HEIGHT FRONT SUSPENSION SYSTEM

(75) Inventor: Anthony J. Sanville, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/419,387

(22) Filed: May 19, 2006

(51) Int. Cl. B60G 3/04; B60G 7/00

(52) U.S. Cl. 280/124.134

(57) ABSTRACT

An adjustable height front suspension system for a golf car includes a frame structure. A support member is fixed to the frame structure and includes first and second apertures. The first aperture is positioned above the second aperture with respect to a ground surface. A shock absorber assembly includes a longitudinally displaceable piston rod and a sleeve fixed to the piston rod. The sleeve is positioned proximate the support member such that a fastener aperture of the sleeve is co-axially aligned with one of the first and second apertures. A fastener is disposed through one of the first and second apertures and the fastener aperture of the sleeve, the first aperture defining a first installation position and the second aperture defining a second installation position.

### FIELD

The present disclosure relates to suspension system devices and methods for configuring suspension systems for a golf car or similar vehicle.

### BACKGROUND

The statements in this section merely provide background information related to the present disclosure and may not constitute prior art.

Golf cars commonly have rigid or single axle suspension systems for both the front steerable wheels and the rear driving wheels. A solid axle provides a stiffer ride feel for the occupants and can also result in reduced control of the golf car over rough terrain and when turning at higher speeds. Some golf car designs have therefore used an independent suspension system at least for the front steerable wheels which eliminates the solid axle and separately suspends each front steerable wheel from the frame or structure of the golf car.

Drawbacks of existing independent suspension designs for golf cars derive from the complexity of permitting a range of wheel/tire operating motion defined by an arc of rotation of the components, such as an A-arm, and the limited linear displacement of a shock absorber assembly. A fixed suspension system installation position for these components is commonly used which can limit the suspension system to a single wheel/tire diameter or a limited vertical displacement due to ground clearance between the vehicle and a ground surface. Alternate platforms therefore cannot be supported by the design of the suspension system.

### SUMMARY

According to several embodiments of the present disclosure, an adjustable height front suspension system for a golf car can include a frame structure. A support member is fixed to the frame structure and includes first and second apertures. The first aperture is positioned above the second aperture with respect to a ground surface. A shock absorber assembly includes a longitudinally displaceable piston rod and a sleeve fixed to the piston rod. The sleeve is positioned proximate the support member such that a fastener aperture of the sleeve is co-axially aligned with one of the first and second apertures. A fastener is disposed through one of the first and second apertures and the fastener aperture of the sleeve, the first aperture defining a first installation position and the second aperture defining a second installation position.

According to further embodiments, an adjustable height front suspension system for a golf car can include a frame structure and a U-shaped support member fixed to the frame structure. The support member includes opposed first and second flanges, and coaxially aligned first and second apertures. The first aperture is created in the first flange and the second aperture is created in the second flange. The first and second apertures define a first aperture axis. Coaxially aligned third and fourth apertures are also created in the support member, the third aperture created in the first flange and the fourth aperture created in the second flange. The third and fourth apertures define a second aperture axis. The first aperture axis is positioned above the second aperture axis with respect to a ground surface. A shock absorber assembly includes a longitudinally displaceable piston rod and a sleeve fixed to the piston rod. The sleeve is positioned between the first and second flanges having a fastener aperture of the sleeve co-axially aligned with one of the first and second aperture axes. A fastener is disposed through the fastener aperture of the sleeve and through either both the first and second apertures or both the third and fourth apertures. The first and second apertures define a first installation position and the third and fourth apertures define a second installation position.

According to still other embodiments, a method is provided for adjusting a height of a golf car. The method includes a first step of orienting the first aperture above the second aperture with respect to a ground surface, the first aperture defining a first installation position and the second aperture defining a second installation position. The method further includes co-axially aligning a fastener aperture of the sleeve with one of the first and second apertures. The method still further includes disposing a fastener through the co-axially aligned one of the first and second apertures and the fastener aperture of the sleeve in one of the first and second installation positions. The method yet still further includes removing the fastener for reinstallation in the other one of the first and second apertures to transition between the first and second installation positions.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front perspective view of a golf car having a front suspension strut according to various embodiments of the present disclosure;

FIG. 2 is a bottom plan view of the golf car of FIG. 1;

FIG. 3 is a front perspective view of a golf car frame and steering assembly together with the adjustable height front suspension of the present disclosure;

FIG. 4 is a front elevational view of a front suspension subassembly of the present disclosure;

FIG. 5 is a side elevational view of the front suspension subassembly of FIG. 4 repositioned to a second connection position;

FIG. 6 is a front elevational view of the golf car of FIG. 1;

FIG. 7 is a side elevational view of the golf car of FIG. 1;

FIG. 8 is a partial front elevational view of a support arm of the present disclosure; and

FIG. 9 is a partial perspective view of the support arm of FIG. 8.

### DETAILED DESCRIPTION

The following description is merely exemplary in nature and is not intended to limit the present disclosure, application, or uses. It should be understood that throughout the drawings, corresponding reference numerals indicate like or corresponding parts and features. As referred to herein, the term “golf car” is synonymously used to describe application of the present disclosure to golf cars as well as sport utility vehicles such as modified golf cars, used for example as food and/or beverage cars, golf cars adapted for use as hunting/sporting clays vehicles, golf course maintenance vehicles, and the like.

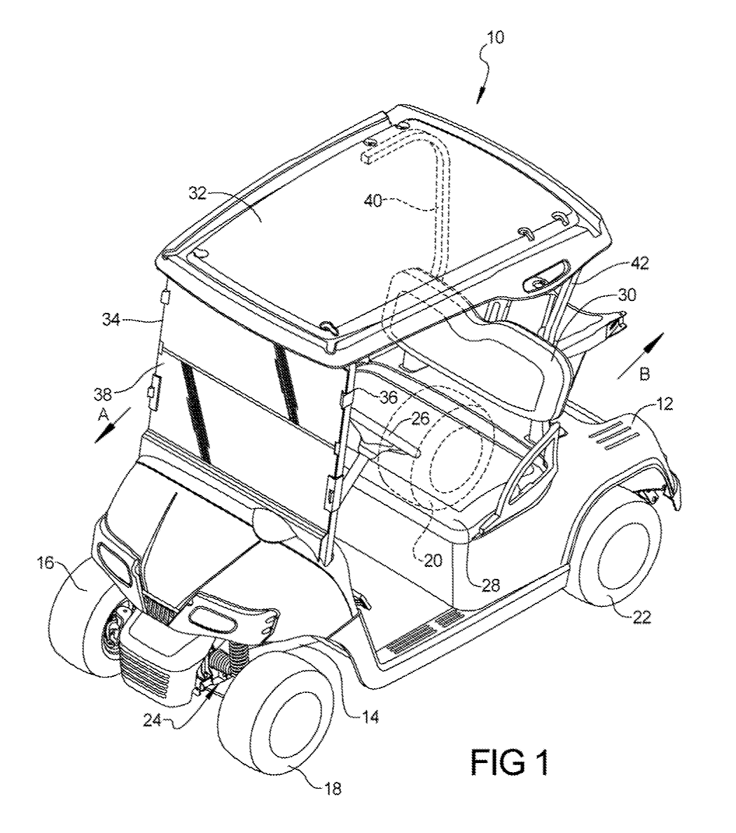

Referring generally to FIG. 1, a golf car 10 can include a body 12 supported from a structural frame 14. Frame 14 can also support a plurality of wheels including a first steerable wheel 16 and a second steerable wheel 18. In addition, powered or driven wheels including a first driven wheel 20 and a second driven wheel 22 are commonly connected to a rear structural portion of frame 14. A front suspension system 24 can also be provided which is adapted for supporting each of the first and second steerable wheels 16, 18. A steering mechanism 26 which commonly includes a steering wheel and a support post assembly is also included to provide the necessary steering input to first and second steerable wheels 16, 18.

Golf car 10 can also include a passenger bench seat 28 and a passenger back support cushion 30. A cover or roof 32 can also be provided which is supported from either body 12 or frame 14 by first and second roof support members 34, 36. A windscreen or windshield 38 can also be provided which is also supported by each of first and second support members 34, 36. A rear section of roof 32 can be supported by each of a first and a second rear roof support element 40, 42. Other items provided with golf car 10 include golf bag support equipment, accessory racks or bins, headlights, side rails, fenders, and the like.

Golf car 10 is commonly propelled by a power unit such as an engine or battery/motor system which can be positioned below and/or behind bench seat 28. Golf car 10 is capable of motion in either of a forward direction “A” or a rearward direction “B”. Each of first and second driven wheels 20, 22 can be commonly supported to frame 14 using multiple designs for a rear suspension system. The present disclosure is therefore not limited by the design of the rear suspension system.

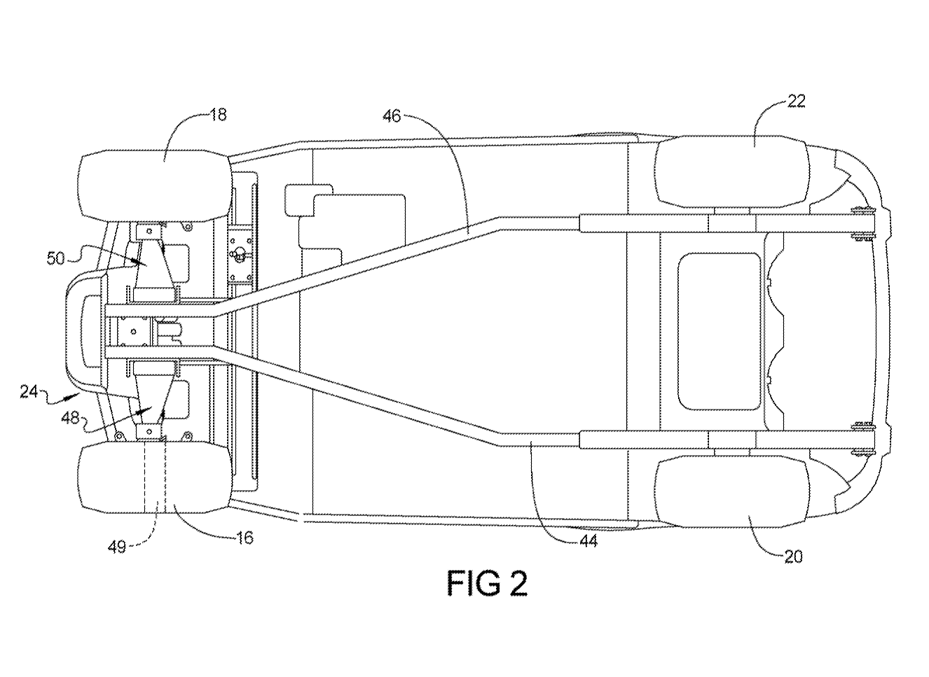

As best seen in reference to FIG. 2, frame 14 can further include a substantially longitudinally arranged first frame member 44 and a mirror image arranged second frame member 46. First and second frame members 44, 46 can be hollow, tubular shaped members created of a metal such as a steel material or similar structural material and formed by welding, extruding, hydroforming, or similar processes. Front suspension system 24 can include each of a first front suspension subassembly 48 supporting first steerable wheel 16 and a second front suspension subassembly 50 supporting second steerable wheel 18.

Front suspension system 24 is configured to permit an extended travel of first and second front suspension subassemblies 48, 50 to provide a comfortable ride and to permit installation of wheels of differing diameters. The extended travel during rotation of first and second front suspension subassemblies 48, 50 with respect to frame 14 permits a total travel of approximately 8.4 cm (3.3 in) while maintaining a side-to-side tread face 49 of at least first and second steerable wheels 16, 18 substantially in contact with a ground surface throughout the total travel.

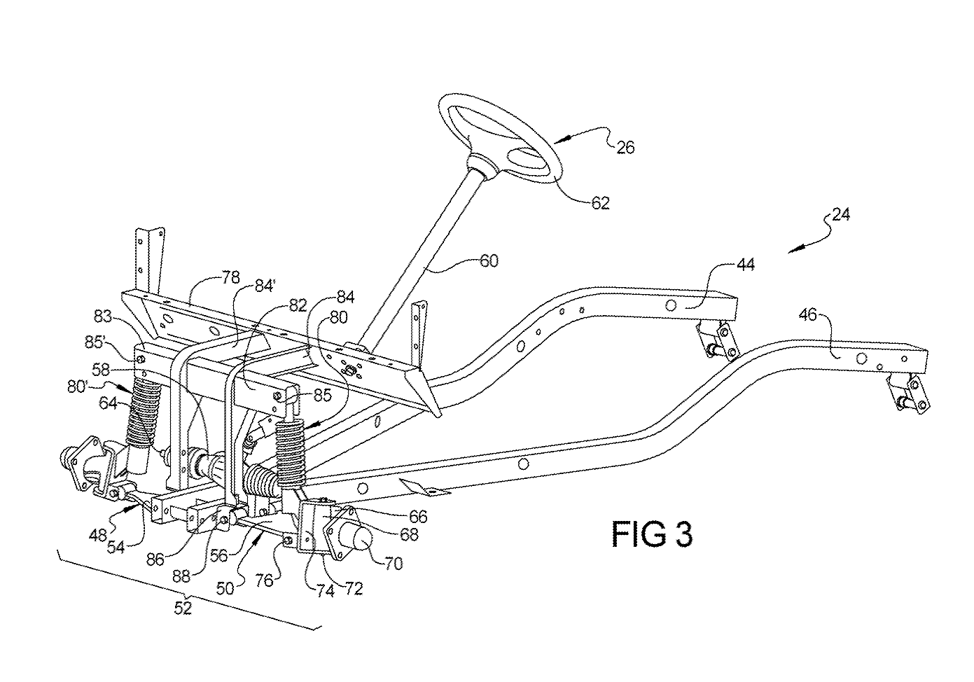

Referring now generally to FIG. 3, first and second front suspension subassemblies 48, 50 together define an independent suspension system 52. Independent suspension system 52 can include a first A-arm 54 and a second A-arm 56. Each of first and second A-arms 54, 56 are identical A-arms which are reversibly disposed in each of the first and second front suspension subassemblies 48, 50. Because each of the first and second front suspension subassemblies 48, 50 are substantially mirror image configurations of each other, only the left hand or second front suspension subassembly 50 will be further discussed herein.

A steering gear 58 coupled to a steering column 60 receives a manual turning force from a steering wheel 62. At least one bellows 64 protects exposed portions of steering mechanism 26 associated with steering gear 58. Receiving input force from steering gear 58, a steering arm 66 can connect to a steering knuckle 68, which is connected to a wheel hub 70 to which second steerable wheel 18 is mounted. Steering knuckle 68 is supported to permit steering of second steerable wheel 18 by a knuckle pin 72 to a knuckle bracket 74. Knuckle bracket 74 can be rotatably coupled to second A-arm 56 to allow upward and downward travel of second steerable wheel 18 using a fastener/pin 76. In addition to the connection provided to second frame member 46 by second A-arm 56, steering knuckle 68 and knuckle bracket 74 can be also connected to a steering support structure 78 using a coil-over-shock strut assembly 80. A second coil-over-shock strut assembly 80′ which is substantially a mirror image configuration of coil-over-shock strut assembly 80 supports first steerable wheel 16.

Coil-over-shock strut assembly 80 is connected to support structure 78 via a support arm 82 fixedly connected to a structural member 84. Second coil-over-shock strut assembly 80′ is similarly connected to steering support structure 78 via a second support arm 83 fixedly connected to a second structural member 84′. A fastener 85 and a second fastener 85′ connect each of coil-over-shock strut assembly 80 and second coil-over-shock strut assembly 80′ respectively to support arm 82 and second support arm 83. Both structural member 84 and second A-arm 56 can be further connected to second frame member 46 using a U-shaped member 86 fixedly connected such as by welding to second frame member 46. A fastener/pin 88 rotatably connects an inboard end of second A-arm 56 to U-shaped member 86.

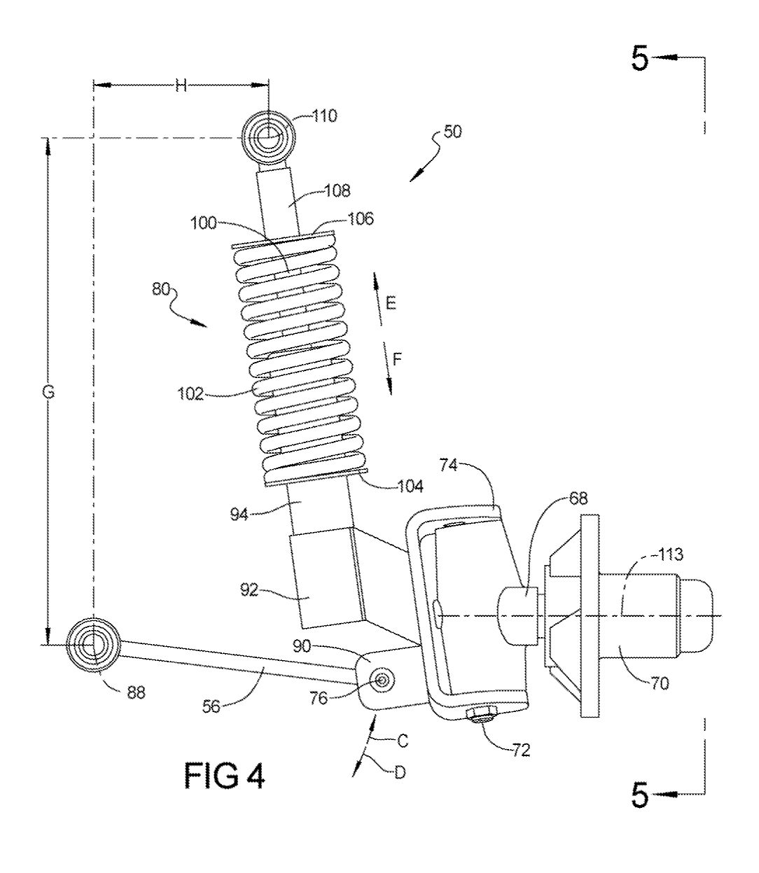

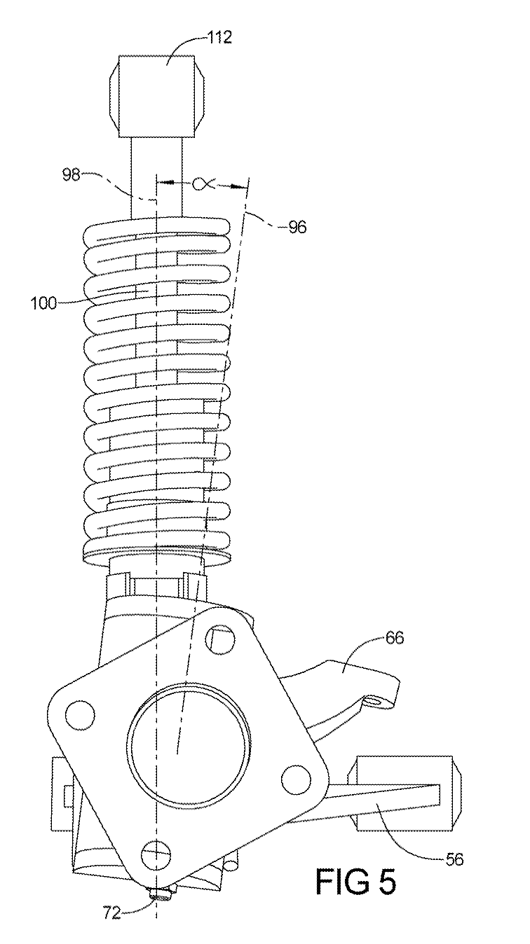

Referring now more specifically to FIGS. 4 and 5, second front suspension subassembly 50 further includes a substantially U-shaped second bracket 90 fixedly connected to knuckle bracket 74. Second bracket 90 includes opposed flanged arms which receive fastener/pin 76 to rotatably connect second A-arm 56. An offset bracket 92 is also fixedly connected to knuckle bracket 74 which receives a cylinder end 94 of coil-over-shock strut assembly 80. A knuckle longitudinal axis 96 defined through steering knuckle 68 and knuckle pin 72 is offset from a shock assembly longitudinal axis 98 defined through a piston rod 100 of coil-over-shock strut assembly 80 by an angle α, which in several embodiments is approximately 6°.

Coil-over-shock strut assembly 80 includes at least offset bracket 92, cylinder end 94, piston rod 100, a biasing element 102 such as a helical or coiled spring retained between a first spring plate 104 fixed to cylinder end 94, and a second spring plate 106 fixed to a tubular member 108 through which piston rod 100 is slidably disposed. A fastener sleeve 110 disposed in a sleeve 112 of coil-over-shock strut assembly 80 supports coil-over-shock strut assembly 80 to support arm 82 using fastener 85.

Second steerable wheel 18 connected to wheel hub 70 initially define a horizontal axis 113 which maximizes tread face 49 of second steerable wheel 18 in contact with a ground surface. As second steerable wheel 18 displaces, it is desirable to maintain the axis of wheel hub 70 substantially on horizontal axis 113. To accomplish this, second A-arm 56 rotates about an axis of fastener/pin 88 in either a first or second arc of rotation “C” or “D” as second bracket 90 is allowed to rotate about fastener/pin 76. Because the longitudinal axis of fastener 110 fixes the position of sleeve 112 relative to support arm 82, as second A-arm 56 deflects about first arc of rotation “C”, biasing element 102 compresses in a compression direction “E”. Similarly, as second A-arm 56 deflects about second arc of rotation “D”, biasing element 102 expands in an expansion direction “F”. First and second positioning dimensions “G” and “H” and a length of second A-arm 56 are predetermined to maintain the longitudinal axis of wheel hub 70 substantially on horizontal axis 113 throughout a range of motion in compression direction “E” and expansion direction “F” of first spring plate 104 with respect to second spring plate 106.

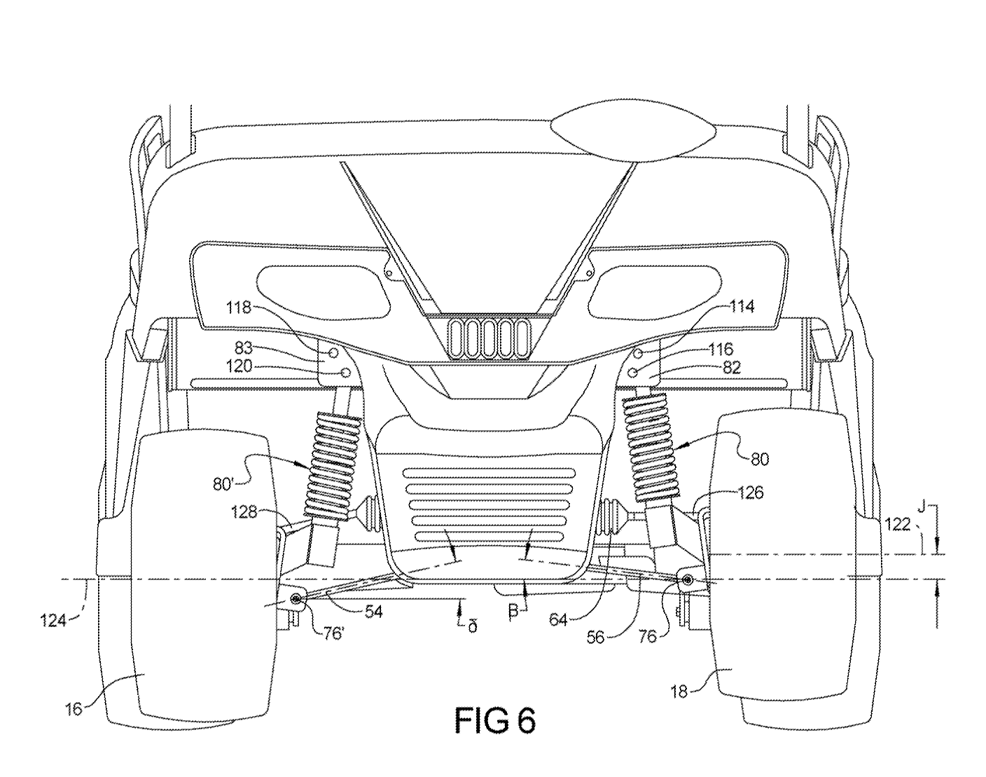

Referring now generally to FIG. 6, the adjustable height suspension system of the present disclosure provides two installation positions which are both shown for comparison purposes. In a typical golf car 10, only one of the installation positions will be selected for both front steerable wheels. Support arm 82 includes an upper or first shock absorber mounting aperture 114 defining a first installation position, and a lower or second shock absorber mounting aperture 116 defining a second installation position. Similarly, support arm 83 includes an upper or first shock absorber mounting aperture 118 and a lower or second shock absorber mounting aperture 120. Coil-over-shock strut assembly 80 supporting second steerable wheel 18 is shown connected to support arm 82 using first shock absorber mounting aperture 114 in the first installation position. Coil-over-shock strut assembly 80′ supporting first steerable wheel 16 is shown connected to support arm 83 using second shock absorber mounting aperture 120 in the second installation position.

When connected as shown, coil-over-shock strut assembly 80 defines a wheel central axis 122, and coil-over-shock strut assembly 80′ defines a wheel central axis 124. A steering control rod 126 provides steering input to second steerable wheel 18. Steering control rod 126 is connected to steering gear 58 (not shown due to bellows 64). A steering control rod 128 provides steering input to first steerable wheel 16. Steering control rod 128 is also connected to steering gear 58 (not shown due to bellows 64). First A-arm 54 together with coil-over-shock strut assembly 80′ rotatably support first steerable wheel 16. Second A-arm 56 together with coil-over-shock strut assembly 80 rotatably support second steerable wheel 18. When the lower or second shock absorber mounting aperture 120 is selected, it should be evident that first A-arm 54 and steering control rod 128 define a greater angle with respect to golf car 10 to accommodate the lower wheel central axis 124. Wheel central axis 124 and wheel central axis 122 are spaced by a height dimension “J”, which, according to several embodiments can be approximately 3.8 cm (1.5 in).

In the first installation position generally shown for second steerable wheel 18 in FIG. 6, coil-over-shock strut assembly 80 is connected to first shock absorber mounting aperture 114. A central plane of second A-arm 56 defines an angle β with respect to a horizontal plane taken through fastener/pin 76. In the second installation position generally shown for first steerable wheel 16, coil-over-shock strut assembly 80′ is connected to second shock absorber mounting aperture 120. A central plane defined through second A-arm 56 defines an angle δ with respect to a horizontal plane taken through a fastener/pin 76′. According to several embodiments, angle δ is greater than angle β as first A-arm 54 rotates downwardly with respect to fastener/pin 88 (not visible in this view) to achieve the second installation position at second shock absorber mounting aperture 120.

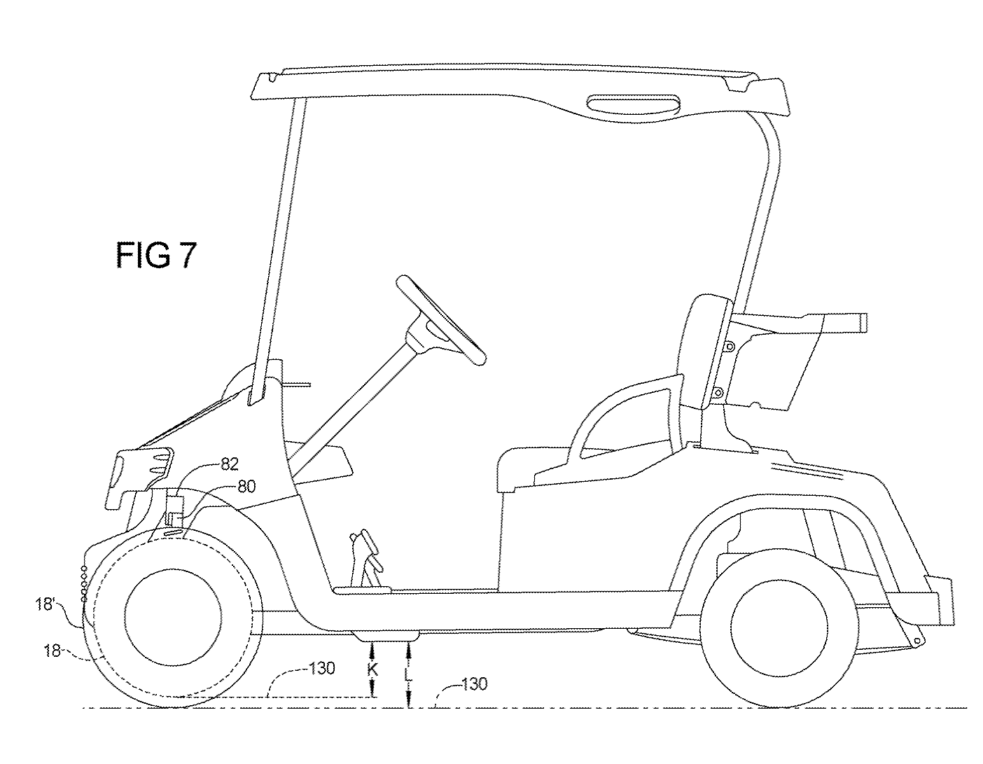

Referring now to FIG. 7, when coil-over-shock strut assembly 80 is installed in the lower or second installation position, first steerable wheel 18 can also be replaced with a larger diameter steerable wheel 18′. A ground clearance “K” provided by first steerable wheel 18 between golf car 10 and a ground surface 130 can be further increased to a ground clearance “L” using larger diameter steerable wheel 18′. Height dimension “J” provides the increased ground clearance “K” of golf car 10 which can be further increased to ground clearance “L” using larger diameter first steerable wheel 18′.

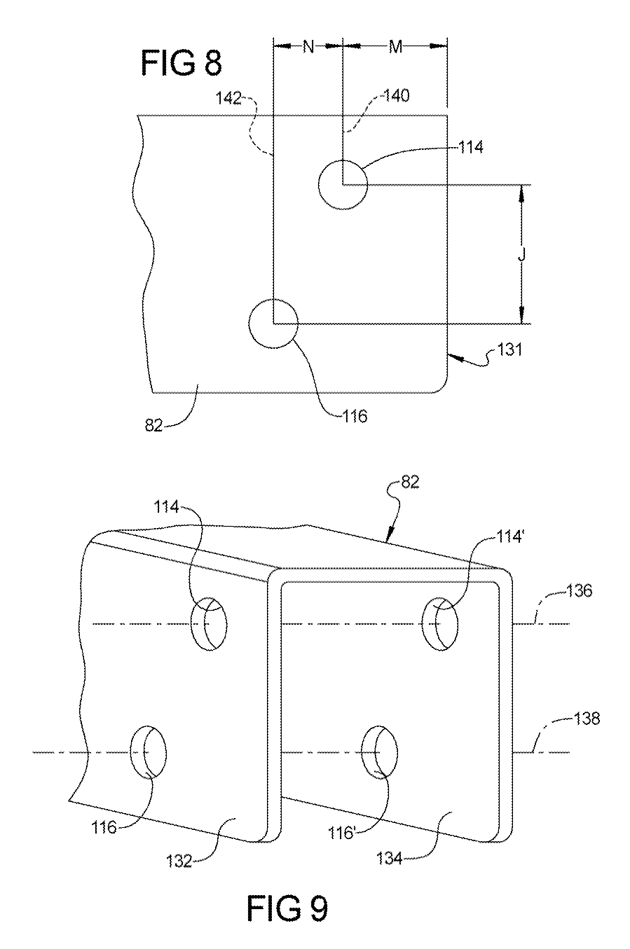

Referring generally now to FIGS. 8 and 9, support arm 82 is shown in greater detail. Details of support arm 83 are similar to support arm 82 and are therefore not shown. First shock absorber mounting aperture 114 is separated vertically from second shock absorber mounting aperture 116 by height dimension “J”. First shock absorber mounting aperture 114 is horizontally spaced from an end 131 of support arm 82 by a dimension “M”. Second shock absorber mounting aperture 116 is horizontally spaced from first shock absorber mounting aperture 114 by an offset dimension “N”. According to several embodiments, each of first and second shock absorber mounting apertures 114, 116 define opposed pairs of apertures. According to several embodiments, first shock absorber mounting aperture 114 is created in a first flange 132 of support arm 82 and an opposed first shock absorber mounting aperture 114′ is created on a second flange 134 of support arm 82.

Both first shock absorber mounting apertures 114, 114′ are coaxially aligned on an aperture axis 136. Similarly, second shock absorber mounting aperture 116 is created in first flange 132 of support arm 82 and an opposed second shock absorber mounting aperture 116′ is created on second flange 134 of support arm 82. Both second shock absorber mounting apertures 116, 116′ are coaxially aligned on a second aperture axis 138. According to several embodiments, a first vertical axis 140 defined through the first mounting aperture 114 is horizontally offset by dimension “N” from a second vertical axis 142 defined through the second mounting aperture 116. Offset dimension “N” permits inward displacement of first or second steerable wheel 16, 18 when repositioning between the first to the second installation positions due to the angular displacement of either the first or second A-arm 54 or 56.

What is claimed is:

1. An adjustable height front suspension system for a golf car, comprising:
a frame structure;
a support member fixed to the frame structure, the support member having:
a first aperture; and
a second aperture, the first aperture positioned above the second aperture with respect to a ground surface;
a shock absorber assembly including a longitudinally displaceable piston rod and a sleeve fixed to the piston rod, the sleeve positionable proximate the support member such that a fastener aperture of the sleeve is co-axially alignable with one of the first and second apertures; and
a fastener disposed through one of the first and second apertures and the fastener aperture of the sleeve, the first aperture defining a first installation position and the second aperture defining a second installation position.

2. The system of claim 1, wherein the support member comprises a U-shaped channel having opposed first and second flanges, both the first and second apertures created in the first flange.

3. The system of claim 2, further comprising a third aperture created in the second flange, wherein the first aperture is coaxially aligned with the third aperture defining a first aperture pair.

4. The system of claim 3, further comprising a fourth aperture created in the second flange, wherein the second aperture is coaxially aligned with the fourth aperture defining a second aperture pair.

5. The system of claim 1, wherein a dimensional difference between the first and second installation positions is approximately 3.8 cm, the first installation position permitting installation of a first wheel and the second installation position permitting installation of a second wheel having a larger diameter than the first wheel.

6. The system of claim 1, further comprising a U-shaped knuckle bracket fixedly connected to the shock absorber assembly.

7. The system of claim 1, further comprising an A-arm rotatably connected to both the knuckle bracket and the frame structure, a longitudinal axis of the A-arm defining a first angle with respect to a horizontal plane in the first installation position and a second angle with respect to the horizontal plane in the second installation position, the second angle greater than the first angle.

8. The system of claim 1, wherein the frame structure further comprises a structural member connected to a steering support structure, the support member being fixedly connected to the structural member and extending substantially transverse to the structural member.

9. The system of claim 1, wherein a first vertical axis defined through the first aperture is horizontally offset from a second vertical axis defined through the second aperture.

10. An adjustable height front suspension system for a golf car, comprising:
a frame structure;
a U-shaped support member fixed to the frame structure, the support member having:
opposed first and second flanges;
coaxially aligned first and second apertures, the first aperture created in the first flange and the second aperture created in the second flanges, the first and second apertures defining a first aperture axis; and
coaxially aligned third and fourth apertures, the third aperture created in the first flange and the fourth aperture created in the second flange, the third and fourth apertures defining a second aperture axis, the first aperture axis positioned above the second aperture axis with respect to a ground surface;
a shock absorber assembly including a longitudinally displaceable piston rod and a sleeve fixed to the piston rod, the sleeve positionable between the first and second flanges such having a fastener aperture of the sleeve co-axially alignable with one of the first and second aperture axes; and
a fastener disposed through the fastener aperture of the sleeve and through one of both the first and second apertures and both the third and fourth apertures, the first and second apertures defining a first installation position and the third and fourth apertures defining a second installation position.

11. The system of claim 10, further comprising a U-shaped knuckle bracket fixedly connected to the shock absorber assembly.

12. The system of claim 11, further comprising a second bracket fixedly connected to the shock absorber assembly.

13. The system of claim 12, further comprising an A-arm rotatably connected to both the second bracket and the frame structure, a longitudinal axis of the A-arm defining a first angle with respect to a horizontal plane in the first installation position and a second angle with respect to the horizontal plane in the second installation position, the second angle being greater than the first angle.

14. The system of claim 10, wherein the frame structure further comprises a structural member connected to a steering support structure, the support member being fixedly connected to the structural member and extending substantially transverse to the structural member.

15. The system of claim 14, wherein the support member further comprises a web transversely connected between the first and second flanges, the first and second flanges oriented downward with respect to the web.

16. The system of claim 10, wherein a first vertical axis intersecting the first aperture axis is horizontally offset from a second vertical axis intersecting the second aperture axis.

17. The system of claim 10, wherein a dimensional difference between the first and second installation positions has a range up to approximately 3.8 cm, the first installation position permitting installation of a first wheel and the second installation position permitting installation of a second wheel having a larger diameter than the first wheel.

18. A method for adjusting a height of a golf car, the golf car having a frame structure, a support member fixed to the frame structure having a first aperture and a second aperture, and a shock absorber assembly including a longitudinally displaceable piston rod and a sleeve fixed to the piston rod, the method comprising:
orienting the first aperture above the second aperture with respect to a ground surface, the first aperture defining a first installation position and the second aperture defining a second installation position;
co-axially aligning a fastener aperture of the sleeve with one of the first and second apertures;
disposing a fastener through the co-axially aligned one of the first and second apertures and the fastener aperture of the sleeve in one of the first and second installation positions; and
removing the fastener for reinstallation in the other one of the first and second apertures to transition between the first and second installation positions.

19. The method of claim 18, further comprising rotating an A-arm during transition between the first and second installation positions.

20. The method of claim 18, further comprising:
installing a first wheel having a first wheel diameter in the first installation position; and
replacing the first wheel with a second wheel having a second wheel diameter greater than the first wheel diameter in the second installation position.
